(19) United States
(12) Patent Application Publication
(10) Pub. No.: US 2013/0054780 A1
(43) Pub. Date: Feb. 28, 2013

(54) Monitoring Geographic Location Changes of Assets in a Cloud

(71) Applicants: Steven A. Bade, Georgetown, TX (US); Harold Moss, III, Danvers, MA (US); Mary Ellen Zurko, Groton, MA (US)

(72) Inventors: Steven A. Bade, Georgetown, TX (US); Harold Moss, III, Danvers, MA (US); Mary Ellen Zurko, Groton, MA (US)

(73) Assignee: International Business Machines Corporation, Armonk, NY (US)

(21) Appl. No.: 13/218,674

(22) Filed: Aug. 26, 2011

(51) Int. Cl. G06F 15/16

(52) U.S. Cl. 709/224

(57) ABSTRACT

Despite the best intentions of a cloud service provider, digital assets of may be moved to a geographic location that deviates from a geographic preference, policy, or setting of the owner of the digital assets. A monitoring tool can monitor network location of a digital asset hosted by a cloud service provider. Movement of the digital asset from a first network location to a second network location is detected. In response to detecting that the digital asset moves, a geographic location that corresponds to the second network location is determined. It is then determined that the geographic location deviates from a geographic setting configured for the digital asset. A notification that the digital asset has been moved to the geographic location that deviates from the geographic setting is generated.

### BACKGROUND

Embodiments of the inventive subject matter generally relate to the field of networks and computers, and, more particularly, to monitoring assets deployed in a cloud for changes in geographic location.

As organizations begin to deploy their applications and data into the cloud, they are faced with a number of new considerations and legal challenges which did not exist in traditional IT models. Different geographic locations have different regulations and laws that govern data and/or services. For instance, Germany and Spain place constraints on where data can reside or be processed. Some states in the United States tax online sales while other states do not. If a business deploys data and/or applications to the cloud, the business relies on a third party to provide the technology for hosting. The third party can relocate data based on their business interests, which can introduce legal consequences for the cloud customer.

### SUMMARY

Embodiments of the inventive subject matter include a method for monitoring geographic location of a digital asset. The method comprises monitoring network location of a digital asset hosted by a cloud service provider, also referred to herein as a third party service provider. Movement of the digital asset from a first network location to a second network location is detected. In response to detecting that the digital asset moves, a geographic location that corresponds to the second network location is determined. It is then determined that the geographic location deviates from a geographic setting configured for the digital asset. A notification that the digital asset has been moved to the geographic location that deviates from the geographic setting is generated.

Embodiments of the inventive subject matter include a computer program product. The computer program product comprises a computer readable storage medium having computer usable program code embodied therewith. The computer usable program code comprises a computer usable program code configured to monitor network location of a digital asset hosted by a cloud service provider. The computer usable program code is configured to detect if the digital asset moves from a first network location to a second network location within the cloud. The computer usable program code is configured to determine a geographic location that corresponds to the second network location if the digital asset moves from the first network location to the second network location. The computer usable program code is configured to determine if the geographic location deviates from a geographic setting configured for the digital asset. The computer usable program code is configured to determine an action associated with the digital asset responsive to determining that the geographic location deviates from the geographic setting configured for the digital asset. The computer usable program code is configured to execute the action.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a conceptual diagram of an example of a cloud service customer detecting movement of digital assets with an asset cloud movement monitoring tool.

FIG. 2 depicts a flowchart of example operations for digital asset cloud movement detection.

FIG. 3 depicts an example computer system with a cloud asset movement monitoring unit.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

A business deploys its digital assets, which can be software and/or data, to a cloud service provider for hosting. A cloud service provider often has cloud resources (i.e., servers, data bunkers) in multiple geographic locations. The multiple geographic locations can be subject to different laws, regulations, policies. The cloud service provider will move digital assets among the different geographic locations for a variety of reasons (e.g., software updates, load balancing, hardware changes, repairs, changes in business concerns). As part of a service agreement, a cloud service customer defines a policy that regulates movement of their digital assets. Despite the best intentions of the cloud service provider, digital assets may be moved to a geographic location that violates the policy. In some cases, the service agreement does not define a policy that regulates geographic location. Whether a policy does not exist or is violated, the cloud service customer that owns the digital assets should be aware of changes in geographic location of their digital assets. As a result of a movement, a digital asset owner may be subject to a different tax code, export regulation, or data privacy laws.

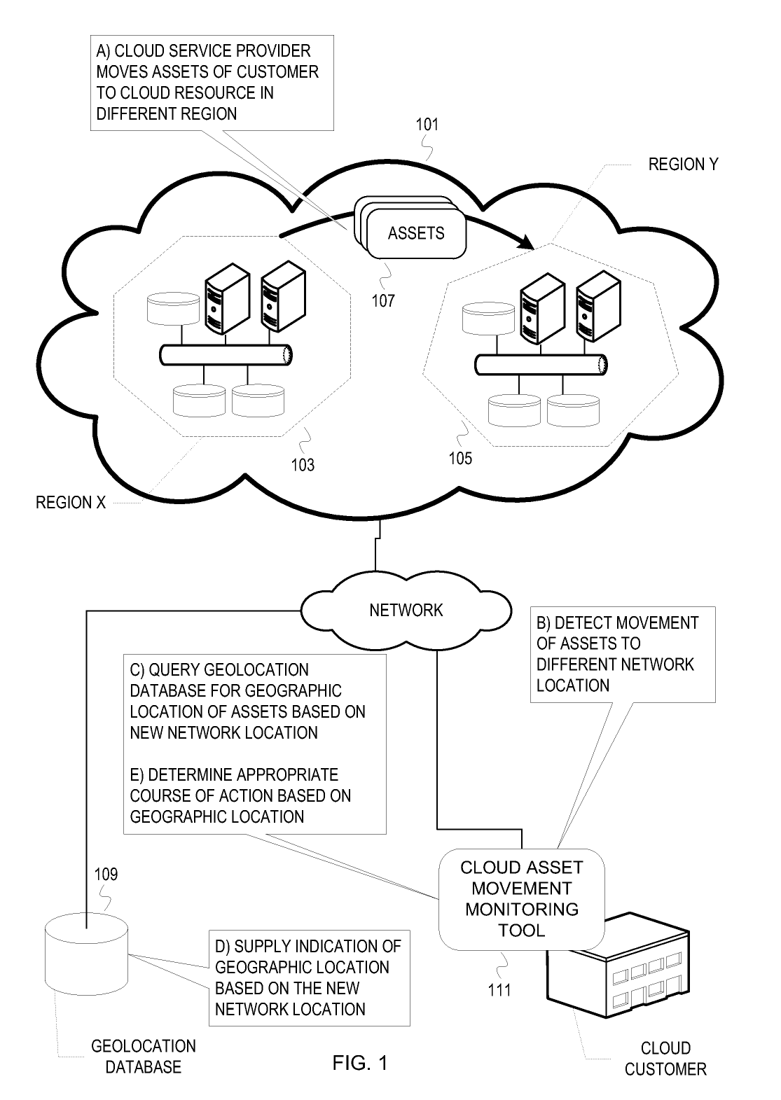

FIG. 1 depicts a conceptual diagram of an example of a cloud service customer detecting movement of digital assets with an asset cloud movement monitoring tool. A cloud 101 represents a conceptual aggregate of resources of a cloud service provider. A non-exhaustive list of examples of cloud resources include storage devices, servers, and database software. In FIG. 1, the cloud 101 includes cloud resources 103 in a Region X and cloud resources 105 in a Region Y. Initially, digital assets 107 of a cloud service customer are hosted in the Region X resources 103. The digital assets 107 can be data and/or software. For example, the digital assets can be patient medical data, research tools, customer data, electronic commerce software, and/or data encryption software.

At a stage A, the cloud service provider moves the digital assets 107 from the Region X resources 103 to the Region Y resources 105. The cloud service provider may be taking servers down in Region X for maintenance. The cloud service provider may be load balancing across regions because the region X resources 103 are suffering from an attack or experiencing a spike in legitimate traffic.

At a stage B, an asset cloud movement monitoring tool 111 detects the movement of the digital assets 107. In FIG. 1, the monitor tool 111 is depicted as hosted by the cloud service customer, but can be hosted by a third party monitoring service. The movement monitoring tool 111 periodically sends requests to the cloud service provider to obtain network location information for the digital assets 107. For example, the monitoring tool 111 sends a request message to a universal resource location specified for the digital assets 107 and obtains an Internet Protocol address. The monitoring tool 111 accesses asset tracking data that indicates a previous network location of the digital assets 107. If the previous network location and the current network location are different, then the monitoring tool 111 determines that the digital assets 107 have moved. Although digital assets move, the digital assets may be in a same geographic location. For instance, the digital assets may move to a different server farm within a same city.

At a stage C, the monitoring tool 111 queries a geolocation database 109 for the geographic location of the digital assets 107 based on the new network location. Although FIG. 1 depicts the monitoring tool 111 as querying the geolocation database 109, embodiments are not so limited. The monitoring tool 111 can submit the query to a service or application that handles querying a geolocation database. In addition, embodiments may query multiple geolocation databases. As an example, the monitoring tool 111 can first query a locally accessible cached geolocation database before querying a remote geolocation database. Furthermore, embodiments are not limited to determining geographic location with a geolocation database. Embodiments can utilize other techniques for determining location of digital assets, and those embodiments can vary with the type of resources hosting the digital assets.

At a stage D, a geolocation service determines the geographic location with the geolocation database 109 using the new network location of the digital assets 107. The geolocation service supplies an indication of the geographic location to the asset cloud movement monitoring tool. If a geographic location is not found for the new network address, subsequent requests can be made with other network location information and the geographic location can be approximate. The asset cloud movement monitoring tool 111 can determine network addresses of devices proximate to the cloud resources 105, and then submit requests to the geolocation service with those network addresses.

At a stage E, the asset cloud movement monitoring tool 111 determines an appropriate course of action based on the geographic location. For instance, the asset cloud movement monitoring tool 111 can determine that the cloud customer is now subject to a different tax code that requires collection of sales tax. The monitoring tool 111 can determine that a request should be sent immediately to the cloud service provider that a geographic constraint of the cloud customer has been violated. The monitoring tool 111 can determine that the digital assets 107 must be encrypted in accordance with privacy laws of Region Y.

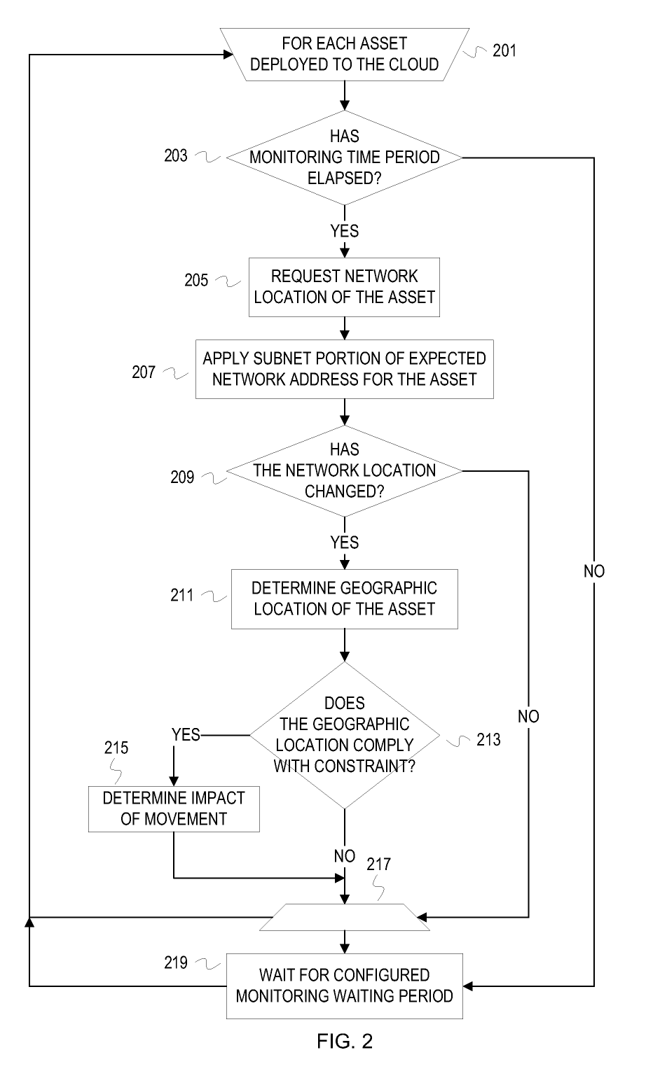

FIG. 2 depicts a flowchart of example operations for digital asset cloud movement detection. FIG. 2 is described with reference to a cloud asset movement monitoring unit, but embodiments are not limited to a particular module or code unit. At block 201, a cloud asset movement monitoring unit begins processing for each asset deployed to the cloud. A cloud service customer may have distinct assets deployed to a cloud. For example, a business might have digital assets that include customer data, inventory data, e-commerce storefront software, and shipping tracking software deployed to a cloud. Digital assets are distinguished from each other for business reasons, but also because each digital asset may be subject to different regulations, laws, or policies (hereinafter “regulations”). A cloud service customer can maintain a data store (e.g., database or data structure) with an entry or record for each digital asset that is subject to different regulations. A monitoring tool traverses the data store by selecting each entry. Each entry identifies a digital asset with an identifier (e.g., string, hash value, serial number, uniform resource identifier).

At block 203, the cloud asset movement monitoring unit determines if a monitoring time period has elapsed. A cloud service customer configures a monitoring time period for each digital asset. A cloud service customer chooses to monitor customer data daily, and monitor e-commerce storefront software monthly. Some embodiments implement a global monitoring time period for all digital assets, monitoring time period by digital asset type (e.g., privacy law sensitive types of digital assets and application type of digital asset), and/or monitoring responsive to input. FIG. 2 presumes an implementation that defines a global monitoring time period for all digital assets. If the monitoring time period has not elapsed, then control flows to block 219. At block 219, the monitoring process waits for the configured monitoring time period to elapse. Once the time period elapses, operations can resume at block 201.

If the time period had elapsed, then a request is made for network location of the digital asset at block 205. Network location can be requested by invoking a function defined in an application programming interface published by the cloud service provider. Network location can be requested with proprietary tools/utilities or other tools, such as ping tools/utilities. Network location can also be determined by sending a network message to the uniform resource identifier (URI) of the digital asset (e.g., a HTTP message). Although a digital asset may move, the URI will often stay the same, or the cloud service provider will provide a notification of the new URI.

After obtaining the network location of the digital asset, the cloud asset movement monitoring unit determines if the digital asset has moved. Some embodiments compare the obtained network location information against expected network location information, and base the determination of movement on match. The expected network location information can be indicated in a database. A digital asset owner can maintain a database of digital assets deployed to a cloud. The database tracks a cloud service provider, uniform resource identifier, last known network location, and time of last network location check for each digital asset. The database also indicate digital asset type, geographic constraint, time monitoring time period, action to take if a geographic constraint violation is determined (e.g., send e-mail, send page, invoke cloud API function), and movement sensitivity value of the digital asset. The movement sensitivity value can represent likelihood that movement will incur regulatory burden and/or likelihood of penalty for movement. Embodiments can indicate geographic constraint by specifying a jurisdiction(s) and whether the jurisdiction is allowed/disallowed. Embodiments can indicate geographic constraint by specifying undesired consequences. For example, a geographic constraint may indicate that a jurisdiction with a sales tax on online sales is disallowed instead of specifying a particular jurisdiction.

In addition to the various data that can be maintained to determine movement and/or geographic constraint violation, some embodiments utilize different techniques for detecting movement in correspondence with the type of network location information being used. The network location information may be an IP address, a MAC address, a RFID, device GPS coordinates, or an embedded hardware number. FIG. 2 presumes an embodiment utilizing an IP address. At block 207, a subnet portion of the expected network address (i.e., last known network address) is applied to the received network address. The expected network address is employed as a mask to ignore movements of digital assets within a same subnet that is within a same geographic location.

At block 209, the cloud asset movement monitoring unit determines if the network location has changed. Pursuant to block 207, if the subnet has changed, then it is assumed that the geographic location may have changed. If the network location has changed, then control flows to block 211. If the network location has not changed, then control flows to block 217.

At block 211, the cloud asset movement monitoring unit determines the geographic location of the asset. As discussed in FIG. 1, a variety of techniques are available for determining a geographic location that corresponds to a network location. Some embodiments access a geolocation database. Some embodiments search based on a name of a data bunker or server farm.

At block 213, the cloud asset movement monitoring unit determines if the geographic location complies with geographic location constraints for the digital assets owned by the cloud service customer. For example, the cloud asset movement monitoring unit determines if a street address or geographic coordinates indicates or falls within a disallowed jurisdiction. Some embodiments determine the geographic locations allowed and/or disallowed as defined by rules/conditions specified in any one of a policy or service legal agreement. Embodiments can evaluate the policy itself (e.g., invoke policy parsing code). Embodiments can access a structure (e.g., hardware table, data structure stored in memory, database) to determine allowed and/or disallowed geographic locations. In addition, the allowed/disallowed geographic locations may be specified differently for different digital assets and/or different types of digital assets. If the geographic location does not comply with the constraints, then control flows to block 217.

At block 215, the cloud asset movement monitoring unit determines the impact of the movement of the digital asset. As mentioned earlier, sales may now be subject to a new or different sales tax. The digital asset may now be subject to an export regulation, privacy law, and/or notice requirement. A service or repository can be accessed that provides an indication of the impact based on type of digital asset and jurisdiction (e.g., country, county, state) that encompasses the geographic location. Once the impact is determined, embodiments can generate a notification communicating the determined impact and/or initiate operations to address consequence of the move. For instance, a sales tax computation function can be activated. A digital asset can be encrypted to comport with a privacy law. In some cases, a regulation can be avoided if moved out of a jurisdiction within a given window of time. In those cases, embodiments may start a timer to countdown the window of time and notify the cloud service customer and/or cloud service provider to move the digital asset from the new geographic location to an allowed geographic location. Embodiments may invoke code that disables software that violates an export regulation, for example. Embodiments may invoke a cloud API function that temporarily moves the digital asset to a safe haven geographic location. Embodiments can also adjust a monitoring time period or activate a monitoring time period in small increments in accordance with the window of time. For instance, a monitoring tool may check network location of a digital asset on a weekly basis. If a movement to a disallowed jurisdiction is detected, the monitoring tool can adjust the monitoring time period to hourly until either the window of time expires or the violation is resolved.

The depicted flowchart is provided as an example to aid in understanding embodiments, and should not be used to limit embodiments. Embodiments can perform additional operations, fewer operations, operations in parallel, and/or operation in a different order. For instance, embodiments may not perform blocks 203 and 219. Embodiments may not perform the masking operation that corresponds to block 207. Embodiments may perform additional operations that consult other services and/or invoke other code to implement operations to remedy the violation of the geographic location constraint. In addition, additional operations can be performed to log geographic location constraint violations by a cloud service provider. A digital asset owner may have digital assets hosted by multiple cloud service providers. The digital asset owner can use the log of violations to influence selection of cloud service providers, modifications to service agreements, limiting a cloud service provider to a type of digital asset that is less sensitive to movement. Moreover, embodiments may determine that a digital asset has moved based on an unexpected response when monitoring. For instance, a monitoring tool can communicate with counterpart process/daemon in a digital asset programmed to provide a particular response established based on a network address or hardware address. If the digital asset has moved, then the response will not comport with an expected response (i.e., the previous network address or hardware address will not be encoded in the response). An unexpected response may also be a lack of a response.

Additionally, embodiments are not limited to resolving violations of geographic constraints. A geographic setting can be configured for a digital asset that is not necessarily a constraint. And deviations from the geographic setting may not trigger a corrective action or compliance action. For instance, a change in geographic location for a digital asset can result in a tax benefit to an online retailer. Subsequent to discovering that a digital asset has moved to a geographic location with a lower sales tax rate or no tax rate on online sales, accounting software can be modified to stop calculating sales tax or reducing sales tax collection. As another example, a digital asset may be moved from a jurisdiction that requires encryption of a customer's digital asset to a jurisdiction without an encryption requirement. Elimination of the encryption process can increase operating efficiency for a customer or allow a customer to stop paying for an encryption service. Embodiments can take actions without generating notifications responsive to discovering a change in geographic location of a digital asset. Embodiments can also obviate generating a notification or taking an action. For example, a customer may configure cloud service settings to log jurisdiction changes and send the log every month or generate a notification if 3 moves occur within a quarter.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

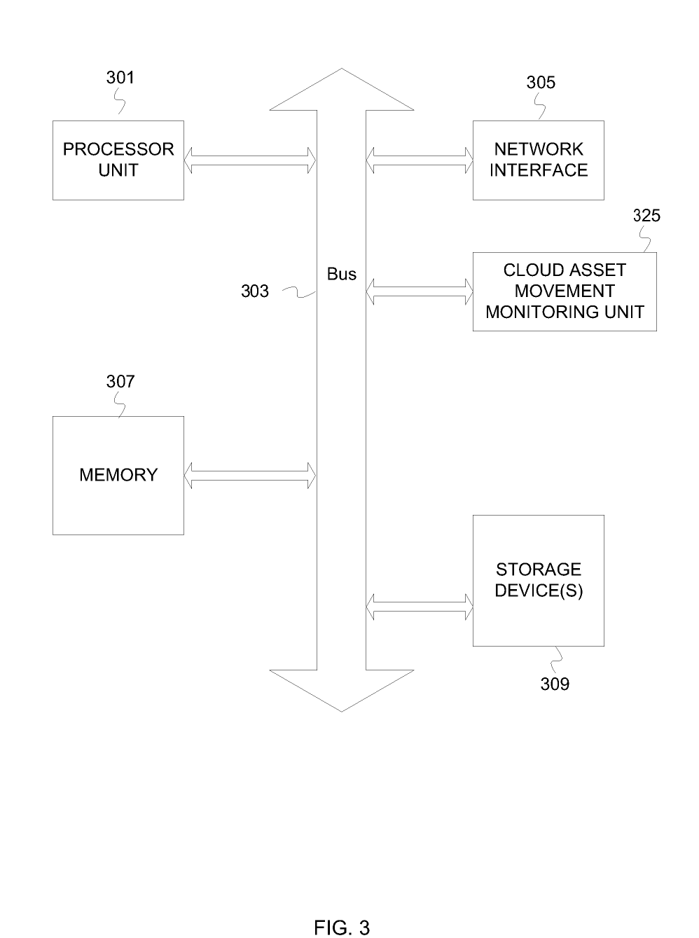

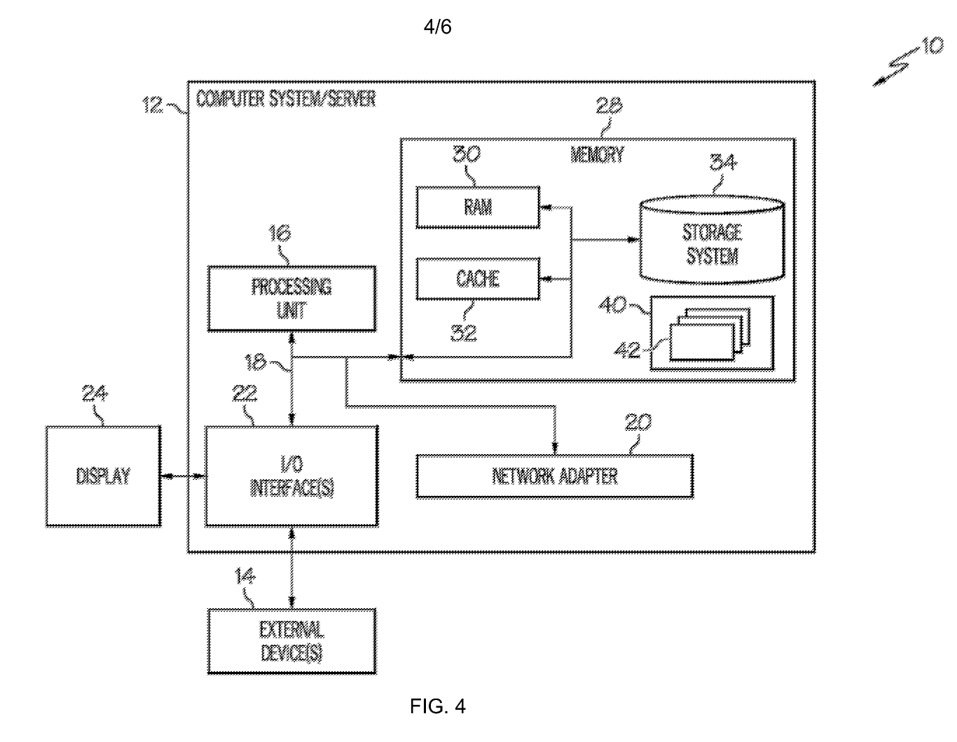

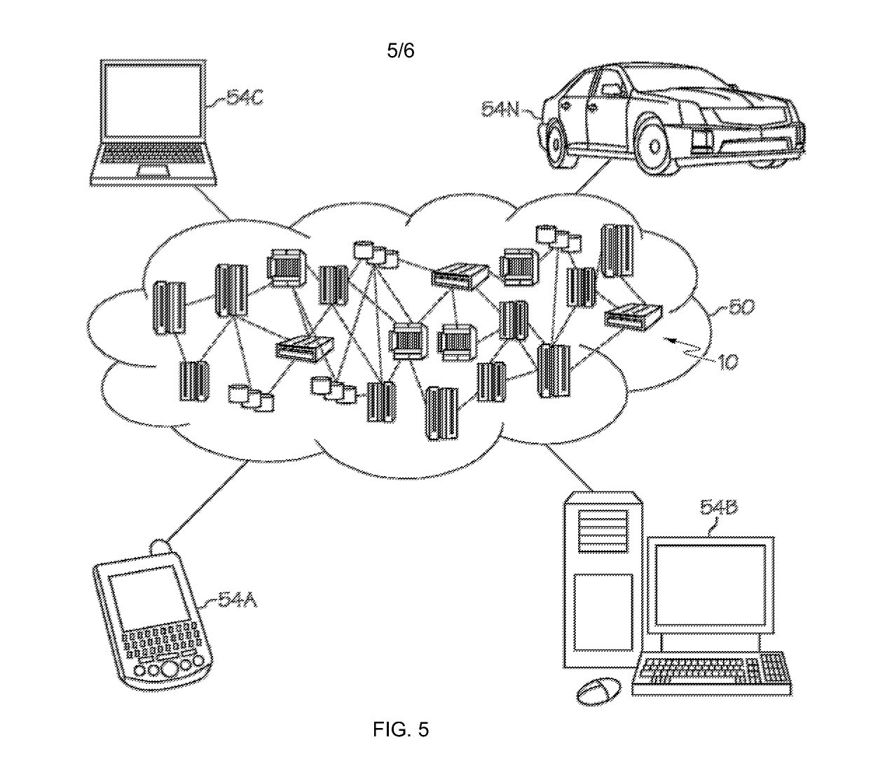

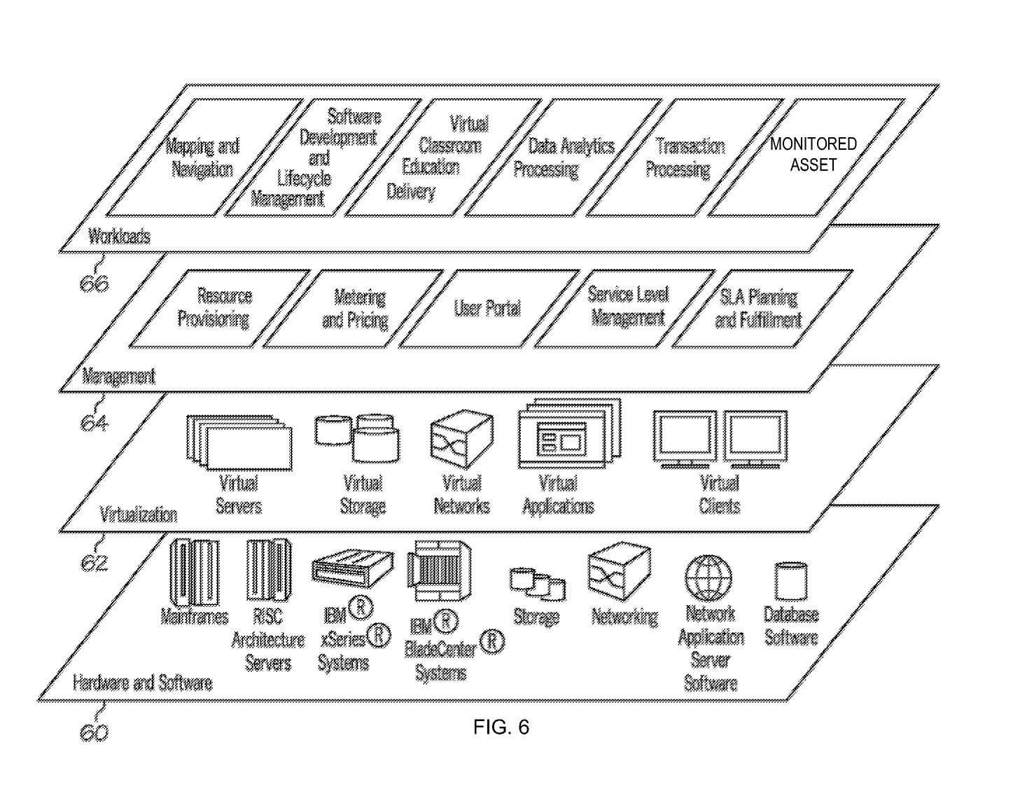

FIG. 3 depicts an example computer system with a cloud asset movement monitoring unit. A computer system includes a processor unit 301 (possibly including multiple processors, multiple cores, multiple nodes, and/or implementing multi-threading). The computer system includes memory 307. The memory 307 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM) or any one or more of the above already described possible realizations of machine-readable media. The computer system also includes a bus 303 (e.g., PCI, ISA, PCI-Express, HyperTransport®, InfiniBand®, NuBus), a network interface 305 (e.g., an ATM interface, an Ethernet interface, a Frame Relay interface, SONET interface, wireless interface), and a storage device(s) 309 (e.g., optical storage, magnetic storage). The system also comprises a cloud asset movement monitoring unit 325. The cloud asset movement monitoring unit 325 monitors a digital asset deployed to a cloud. The cloud asset movement monitoring unit 325 detects movement of the digital asset based, at least in part, on a change in network location of the digital asset. The cloud asset movement monitoring unit 325 can resolve the new network location to a geographic location, and determine whether the new geographic location violates geographic location constraints for the digital asset. The system memory 307 can host program instructions that embody functionality to implement at least some of the functionality that facilitates the cloud asset movement monitoring unit 325. Some or all of the functionality may be implemented with program instructions embodied in a computer program product. Any one of these functionalities may be partially (or entirely) implemented in hardware and/or on the processing unit 301. For example, the functionality may be implemented with an application specific integrated circuit, in logic implemented in the processing unit 301, in a co-processor on a peripheral device or card. Further, realizations may include fewer or additional components not illustrated in FIG. 3 (e.g., video cards, audio cards, additional network interfaces, peripheral devices). The processor unit 301, the storage device(s) 309, and the network interface 305 are coupled to the bus 303. Although illustrated as being coupled to the bus 303, the memory 307 may be coupled to the processor unit 301.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services)that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and supporting a monitored asset.

While the embodiments are described with reference to various implementations and exploitations, it will be understood that these embodiments are illustrative and that the scope of the inventive subject matter is not limited to them. In general, techniques for detecting movement of a digital asset within a cloud as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the example configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for monitoring geographic location of a digital asset, the method comprising:
monitoring network location of the digital asset hosted by a third party service provider;
detecting that the digital asset moves from a first network location to a second network location;
responsive to said detecting that the digital asset moves, determining a geographic location that corresponds to the second network location;
determining that the geographic location deviates from a geographic setting configured for the digital asset; and
generating a notification that the digital asset has been moved to the geographic location that deviates from the geographic setting.

2. The method of claim 1, wherein said determining that the geographic location deviates from the geographic setting configured for the digital asset comprises determining a jurisdiction of the geographic location.

3. The method of claim 2 further comprising at least one of determining that the geographic setting indicates the jurisdiction as disallowed and determining that the jurisdiction imposes a regulation indicated by the geographic constraint as disallowed.

4. The method of claim 1, wherein said monitoring the network location of the digital asset comprises requesting network location information of the digital asset from the third party service provider at a given interval, wherein the third party service provider comprises a cloud service provider.

5. The method of claim 4, wherein said requesting the network location information of the digital asset comprises:
sending a message to a uniform resource identifier of the digital asset;
determining that the uniform resource identifier resolves to a network address of the second network location based, at least in part, on a response to the message.

6. The method of claim 4 further comprising:
sending a message to a network address of the first network location;
determining that a response to the message does not conform to an expected response.

7. The method of claim 1, wherein said detecting that the digital asset moves from the first network location to the second network location comprises:
determining that a first network address of the first network location does not match a second network address of the second network location.

8. The method of claim 7 further comprising masking out parts of the first network address and the second network address that do not identify a subnet, wherein the first network address indicates a subnet different than the second network address.

9. The method of claim 1 further comprising:
determining an action associated with the digital asset responsive to said determining that the geographic location deviates from the geographic setting configured for the digital asset; and
executing the action.

10. The method of claim 9 further comprising:
counting down a window of time for moving the digital asset to a different jurisdiction that comports with the geographic constraint; and
monitoring the digital asset at the second network location at a greater frequency than monitored at the first network location.

11. A computer program product for monitoring geographic location of digital assets, the computer program product comprising:
a computer readable storage medium having computer usable program code embodied therewith, the computer usable program code comprising a computer usable program code configured to:
monitor network location of a digital asset hosted by a third party service provider;
detect if the digital asset moves from a first network location to a second network location managed by the third party service provider, wherein the third party service provider managers a cloud;
determine a geographic location that corresponds to the second network location if the digital asset moves from the first network location to the second network location;
determine that the geographic location deviates from a geographic setting configured for the digital asset; and
generate a notification that the digital asset has been moved to the geographic location that deviates from the geographic setting.

12. The computer program product of claim 11, wherein the computer usable program code configured to determine that the geographic location deviates from the geographic setting configured for the digital asset comprises the computer usable program code configured to determine a jurisdiction of the geographic location.

13. The computer program product of claim 12, wherein the computer usable program code further configured to, at least one of, determine that the geographic setting indicates the jurisdiction as disallowed and determine that the jurisdiction imposes a regulation indicated by the geographic constraint as disallowed.

14. The computer program product of claim 11, wherein the computer usable program code configured to monitor the network location of the digital asset comprises the computer usable program code configured to request network location information of the digital asset from the third party service provider at a given interval.

15. The computer program product of claim 14, wherein the computer usable program code configured to request the network location information of the digital asset comprises the computer usable program code configured to:
send a message to a uniform resource identifier of the digital asset;
determine that the uniform resource identifier resolves to a network address of the second network location based, at least in part, on a response to the message.

16. The computer program product of claim 14, wherein the computer usable program code is further configured to:
send a message to a network address of the first network location;
determine that a response to the message does not conform to an expected response.

17. The computer program product of claim 11, wherein the computer usable program code configured to detecting if the digital asset moves from the first network location to the second network location comprises the computer usable program code configured to:
determine that a first network address of the first network location does not match a second network address of the second network location.

18. The computer program product of claim 17, wherein the computer usable program code is further configured to mask out parts of the first network address and the second network address that do not identify a subnet, wherein the first network address indicates a subnet different than the second network address.

19. The computer program product of claim 11, wherein the computer usable program code is further configured to:
determine an action associated with the digital asset responsive to determining that the geographic location deviates from the geographic setting configured for the digital asset; and
executing the action.

20. The computer program product of claim 19, wherein the computer usable program code is further configured to:
count down a window of time for moving the digital asset to a different jurisdiction that comports with the geographic constraint; and
monitor the digital asset at the second network location at a greater frequency than monitored at the first network location.

21. A computer program product for monitoring geographic location of digital assets, the computer program product comprising:
a computer readable storage medium having computer usable program code embodied therewith, the computer usable program code comprising a computer usable program code configured to:
monitor network location of a digital asset hosted by a third party service provider;
detect if the digital asset moves from a first network location to a second network location managed by the third party service provider;
determine a geographic location that corresponds to the second network location if the digital asset moves from the first network location to the second network location;
determine if the geographic location deviates from a geographic setting configured for the digital asset; and
determine an action associated with the digital asset responsive to determining that the geographic location deviates from the geographic setting configured for the digital asset; and
executing the action.

22. The computer program product of claim 21, wherein the computer usable program code configured to determine that the geographic location deviates from the geographic setting configured for the digital asset comprises the computer usable program code configured to determine a jurisdiction of the geographic location, wherein the third party service provider comprises a cloud service provider.

23. The computer program product of claim 21, wherein the computer usable program code is further configured to:
count down a window of time for moving the digital asset to a different jurisdiction that comports with the geographic constraint; and
monitor the digital asset at the second network location at a greater frequency than monitored at the first network location.

24. An apparatus comprising:
a processor unit;
a network interface coupled with the processor unit; and
a computer readable storage medium having computer usable program code embodied therewith, the computer usable program code comprising a computer usable program code configured to:
monitor network location of a digital asset hosted by a third party service provider;
detect if the digital asset moves from a first network location to a second network location managed by the third party service provider;
determine a geographic location that corresponds to the second network location if the digital asset moves from the first network location to the second network location;
determine that the geographic location deviates from a geographic setting configured for the digital asset; and
generate a notification that the digital asset has been moved to the geographic location that deviates from the geographic setting.

25. The apparatus of claim 24, wherein the computer usable program code is further configured to:
determine an action associated with the digital asset responsive to determining that the geographic location deviates from the geographic setting configured for the digital asset; and
executing the action, wherein the third party service provider comprises a cloud service provider and the first network location and the second network location are within a cloud managed by the cloud service provider.
